(19) United States
(12) Patent Application Publication
(10) Pub. No.: US 2023/0065342 A1
(43) Pub. Date: Mar. 2, 2023

(54) USING QUICK RESPONSE CODE TO EXTEND ACCESS TO AN ACCOUNT

(71) Applicant: Capital One Services, LLC, McLean, VA (US)

(72) Inventors: Jennifer Chu, San Francisco, CA (US); Jonatan Yucra Rodriguez, San Francisco, CA (US); Alexander Golovanov, Lafayette, CA (US)

(21) Appl. No.: 17/464,270

(22) Filed: Sep. 1, 2021

(51) Int. Cl. G06Q 20/36; G06K 19/06; H04L 9/30

(52) U.S. Cl. CPC G06Q 20/367; G06K 19/06037; H04L 9/30

(57) ABSTRACT

Systems as described herein may use computer-readable code to extend access to an account. A delegation server may receive a predetermined limit and an activity period associated with an account from a first user who is an account holder. A virtual number may be generated with a reference to the account. The delegation server may encrypt the virtual number and generate a computer-readable code based on the virtual number. The computer-readable may be provided to a digital wallet of a second user to delegate the second user to have temporary access to the underlying account. The second user may then use the temporary access to the underlying account to make one or more purchases in accordance with the restrictions put in place by the accountholder.

### FIELD OF USE

Aspects of the disclosure relate generally to data management and more specifically to the data privacy and data security.

### BACKGROUND

After a payment card (e.g. a credit card) is issued by a financial institution, a cardholder may wish to extend access to the credit line of the card to a family member or a third party who is not the account holder for temporary use. For example, an elderly person may wish to delegate the temporary access to her credit card to a helper who would purchase groceries for the elderly in a pandemic. In a conventional system, once the card number and card verification value (CVV) are provided to a recipient, the information may not be revoked readily, and the recipient may have full access to the credit line for an indefinite time without restrictions. Disclosure of the confidential data associated with the payment card may expose the card number and other confidential data to unauthorized parties. As a result, conventional card system does not have the flexibility to delegate the usage of the card while preserving the privacy and security of the confidential data.

Aspects described herein may address these and other problems, and generally improve the quality, efficiency, security and privacy of management of confidential payment data so that temporary access to a credit line may be delegated to a party who is not the account holder.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems as described herein may include features for extending access to an account to a third party. Access may be provided via a computer-readable code, such as a Quick Response (QR) code, a bar code, a token, or an equivalent thereof. A delegation system may receive a predetermined limit and/or an activity period associated with the account. The delegation system may receive such information from a first user on a first computing device who may be the account holder. The delegation system may generate a virtual number to delegate temporary access to the account to a second user on a second computing device. The virtual number may be associated with the account and mapped to a record comprising an identifier of the account, the predetermined limit, and/or the activity period. The virtual number may be encrypted with a public key, for example, an identifier of the second computing device. The delegation system may generate a computer-readable code (e.g., QR code, bar code, etc.) based on the virtual number, and the computer-readable code may include an encrypted form of the virtual number. Accordingly, the computer-readable code may be provided to a digital wallet of the second user on the second computing device, and the second user may use the account to make purchases, while not being the account holder of the underlying account.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system for using computer-readable code to extend access to an account;

FIG. 2 shows an example computing device in accordance with one or more aspects described herein;

FIG. 3 shows a flow chart of a process for using computer-readable code to extend access to an account according to one or more aspects of the disclosure;

FIG. 4 shows a flow chart of a process for processing a transaction request based on a computer-readable code according to one or more aspects of the disclosure; and

FIGS. 5A-B show an example of using the computer-readable code to extend access to an account according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for using computer-readable code to extend access to an account. The computer-readable code may include a QR code, a bar code, a token, etc. The account may comprise a bank account or a credit account. A delegation system may store, in a delegation database, a record that includes a virtual number, an identifier of the account, a predetermined limit, and/or an activity period associated with temporary access to the account. The delegation system may receive a transaction request including transaction information and/or payment information associate with the computer-readable code. The transaction information may comprise a transaction amount, a transaction timestamp, a merchant identifier, a location of the transaction, etc. The payment information may comprise the virtual number and/or information identifying the user and/or device associated with the virtual number. The delegation system may retrieve the record from a delegation database based on the payment information. The record may comprise the predetermined limit and/or the activity period associated with the temporary access to the account. The delegation system may compare the transaction information and/or the payment information with the retrieved record, and process the transaction request based on the comparison. Subsequently, the delegation system may grant the transaction request upon a determination that the transaction amount is within the predetermined limit, the transaction timestamp falls within the activity period, that the user and/or device is authorized to make the transaction, or any combination thereof. Alternatively, the delegation system may deny the transaction request, for example, based on a determination that the transaction amount exceeds the predetermined limit, the transaction timestamp falls outside the activity period, or the user and/or device are not authorized to make the transaction.

The delegation system as described herein allows for revoking the temporary access to the account, for example, based on a request from the first user (e.g., a cardholder or an account holder). The predetermined limit and/or the activity period may be updated, for example, based on a request from the first user (e.g., a cardholder or an account holder). The delegation system further allows for generating the virtual number by applying a one-way function to the identifier of the account. The delegation system may extend a temporary access to an account via a virtual card comprising the computer-readable code. The account holder of the virtual card may set an artificial credit limit and/or an activity period. The account holder may dynamically change the artificial credit limit and/or activity period without changing the computer-readable code.

### Delegation Systems

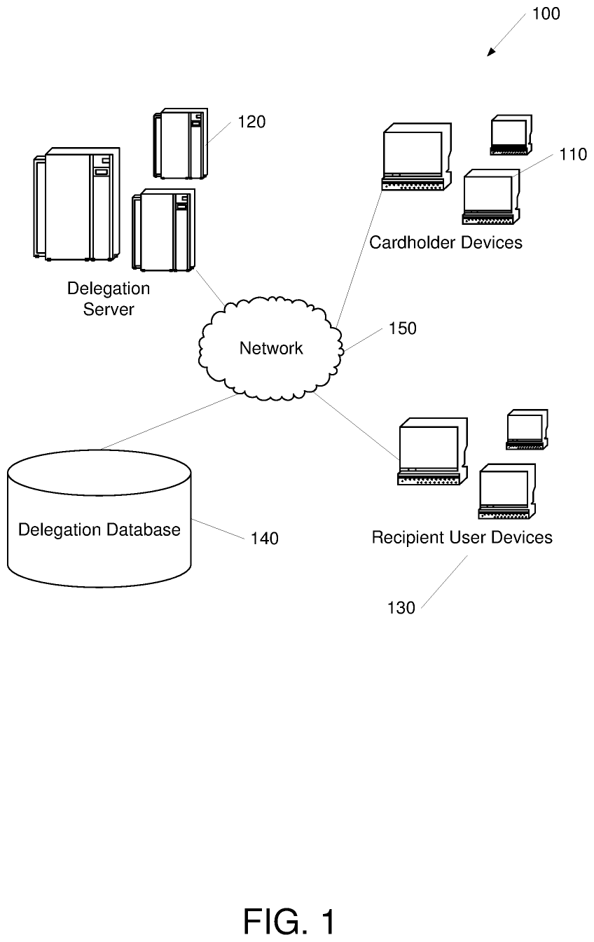

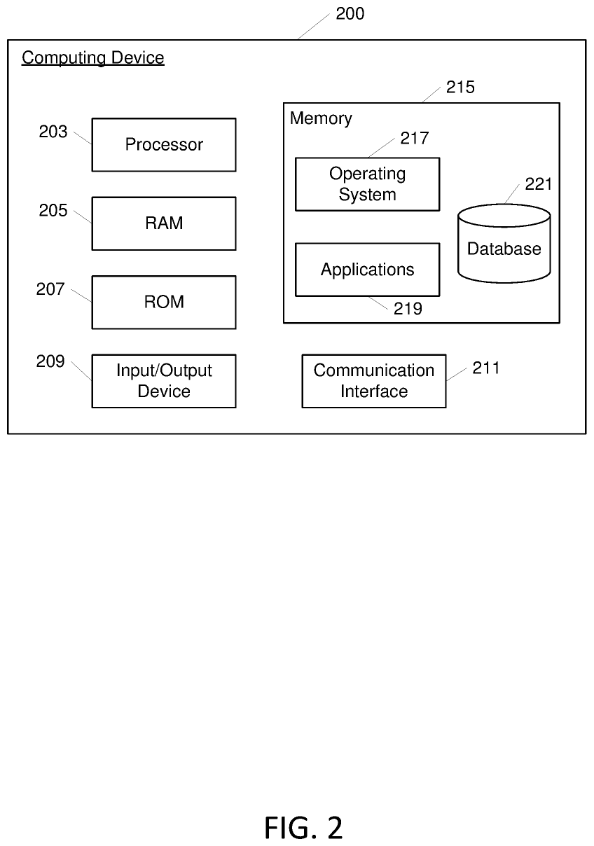

FIG. 1 shows an example of a system 100 where delegation may occur. System 100 may include at least one cardholder device 110, at least one delegation server 120, at least one recipient user device 130, and/or at least one delegation database 140 all interconnected via a network 150. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 2.

Cardholder devices 110 may be any device belongs to a user who may be an account holder of a credit account or a bank account. Cardholder devices 110 may be any device capable of delegating a temporary access to an account associated with a payment card to a recipient who is not the account holder. For example, cardholder devices 110 may execute an application to access a configuration page on a web site of a financial institution. The cardholder may generate a virtual card linked to the original card that may grant temporary access to the credit line of the original card. On the configuration page, the cardholder may set a predetermined limit and/or an activity period for the virtual card. The cardholder may stipulate, for example, that the recipient may have a spend limit of $50 with an activity period of 10 hours. The cardholder may stipulate whether the virtual card may expire after one time use or allow for multiple uses. The cardholder may stipulate a type of spending that is allowed for the virtual card. For example, the virtual card may be used to purchase groceries, but not alcohol. The cardholder may also stipulate the payment method of the virtual card. For example, the virtual card may be used for payment associated with Google Pay, but not for Apple Pay.

Cardholder devices 110 may enable the cardholder to select an option to deliver the virtual card to the recipient. For example, the virtual card may be sent to the recipient via an email or text message, and the recipient may click on a link in the email or text message to access the virtual card. The virtual card may be delivered to a recipient's digital wallet. The virtual card may also be delivered to the recipient via Near Field Communication (NFC) or other short-range wireless communications by bringing cardholder devices 110 to the proximity of recipient user devices 130.

Cardholder devices 110 may include computing devices, such as laptop computers, desktop computers, mobile devices, smart phones, tablets, and the like. According to some examples, cardholder devices 110 may include hardware and software that allow them to connect directly to network 150. Alternatively, cardholder devices 110 may connect to a local device, such as a personal computer, server, or other computing device, which connects to network 150. Cardholder devices 110 may send a request to delegation system 120 to generate a virtual card to delegate a temporary access to the underlying card based on the configuration information provided by cardholder devices 110.

Delegation system 120 may receive, process, and/or store confidential data such as an account information including an account number for a credit card or bank card, expiration date, CVV, or the virtual card information including the configuration information stipulated by cardholder devices 110. Delegation system 120 may receive a request from cardholder devices 110 to generate a virtual card and/or generate a virtual number linked to the underlying credit card or other bank card, such as a debit card or gift card. Delegation system 120 may receive configuration information from cardholder devices 110, such as a predetermined limit, an activity period, whether the virtual card may expire after one time use or allow for multiple uses, a type of spending and a payment method of the virtual card. Delegation system may generate a virtual number for the virtual card that is linked to the underlying card. For example, the virtual number may mimic a primary account number (PAN) which may be an 8-19 digits number generated as a unique identifier for a primary account. PAN may be issued to payment cards such as a credit card, a debit card as well as other cards that store value like a gift card. PAN may be used as an identifier for a credit card account.

Delegation system 120 may encrypt the virtual number. For example, the virtual number may be encrypted with a symmetric key of a recipient user device, such as an identifier of the recipient device (e.g. a phone number of the recipient's smartphone). The virtual number may also be encrypted with a public key and later decrypted with a private key. The delegation system may generate a computer-readable code, for example, a QR code or a bar code, based on the encrypted virtual number. The generated computer-readable code may be delivered to recipient user devices 130 to be used as a virtual card that may grant temporary access to the account the underlying card.

Recipient user devices 130 may be any device that belongs to a recipient who may receive the computer-readable code representing the virtual card. The recipient may be a family member, such as a child or relative who may be granted temporary access to the underlying card via the virtual card. The recipient may be a caregiver such as a babysitter that takes care of the children and the cardholder would like to grant a one-time access for $50 for the duration of the night so that the babysitter may purchase pizza for the children. The recipient may be a caregiver who helps an elderly person to purchase groceries in a pandemic. The elderly would like to grant multiple accesses for $500 for 24 hours so that the caregiver may go to multiple stores to purchase groceries and/or obtain prescription drugs. Recipient user devices 130 may be any device capable of receiving the computer-readable code. For example, recipient user devices 130 may execute an application to communicate with delegation server 120 and the recipient may register as a user with a financial institution to execute the application. But the recipient may not need to have any financial account or own any payment card associated with the financial institution.

Recipient user devices 130 may receive a virtual card linked to the original card that may grant temporary access to an account of the original card. Recipient user devices 130 may receive the virtual card in the form of the computer-readable code via an email or text message, and the recipient may click on a link in the email or text message to access the virtual card. Alternatively, the recipient devices 130 may obtain the virtual card by reading the computer-readable code (e.g., QR code, bar code, etc.) from the cardholder's device. Recipient user devices 130 may receive the computer-readable code as a token in the recipient's digital wallet. Recipient user devices 130 may receive the computer-readable code via Near Field Communication (NFC) or other short-range wireless communications when the cardholder devices 110 may be in the proximity of recipient user devices 130. Once the computer-readable code is received and accepted by the recipient, recipient user devices 130 may send a notification to cardholder devices 110 that the virtual card has been activated.

Recipient user devices 130 may include scanner, a camera, camera-arrays, camera-enabled mobile-devices, etc. Alternatively, recipient user devices 130 may include computing devices, such as laptop computers, desktop computers, mobile devices, smart phones, tablets, and the like. According to some examples, recipient user devices 130 may include hardware and software that allow them to connect directly to network 150. Alternatively, recipient user devices 130 may connect to a local device, such as a personal computer, server, or other computing device, which connects to network 150. In some embodiments, recipient user devices 130 may include a scanner configured to scan the computer-readable code to obtain the virtual card information.

Delegation database 140 may store a record comprising the virtual number, the identifier of the underlying account, the predetermined limit, the activity period associated with the account or other configuration information (such as a one-time use policy, type of purchase, delivery method) associated with the virtual card. For example, delegation database 140 may store a record including information such as a virtual number in the form of, for example, a 16-digit PAN, a real PAN corresponding the underlying credit card, the $50 spend limit, the activity period for 10 hours for a temporary delegation to a babysitter. The record may also store the telephone number of the babysitter's mobile device which may be used as an encryption key to encrypt the virtual number to generate the corresponding computer-readable code.

Delegation server 120 may later receive a transaction request from recipient user devices 130 for the authentication of a transaction. The request may comprise transaction information and payment information associate with the computer-readable code. For example, the transaction information may include a transaction amount, a transaction timestamp, a place of transaction, and/or merchant information. The request may also include payment information such as the virtual number and/or information identifying the user and/or device associated with the virtual number. Delegation server 120 may retrieve a record from delegation database 140, for example, based on the virtual number. The record may include the identifier (e.g. account number) of the underlying account, the predetermined limit, the activity period associated with the account, and/or other restrictions on the virtual card. Delegation server 120 may compare the transaction information with the retrieved record, and process the transaction request based on the comparison. For example, delegation server 120 may grant the transaction request upon a determination the transaction amount is within the predetermined limit, and the transaction timestamp falls within the activity period. Delegation server 120 server may also compare the merchant information with a type of purchase and grant the transaction request if the criterion is met. Delegation server 120 may deny the transaction request upon a determination that the transaction amount exceeds the predetermined limit, or the transaction timestamp falls outside the activity period. Delegation server 120 may deny the transaction request if other criteria (one-time purchase or type of purchase) are not met.

Cardholder devices 110, delegation server 120, recipient user devices 130, and/or delegation database 140 may be associated with a particular authentication session. Delegation server 120 may receive, process, and store a variety of transaction records, other confidential information such as virtual numbers, computer-readable codes, and/or receive and send transaction records, configuration information, computer-readable codes from/to cardholder devices 110 and recipient user devices 130 as described herein. However, it should be noted that any device in system 100 may perform any of the processes and/or store any data as described herein. Some or all of the data described herein may be stored using one or more databases. Databases may include, but are not limited to relational databases, hierarchical databases, distributed databases, in-memory databases, flat file databases, XML databases, NoSQL databases, graph databases, and/or a combination thereof. The network 150 may include a local area network (LAN), a wide area network (WAN), a wireless telecommunications network, and/or any other communication network or combination thereof.

The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in delegation system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

### Computing Devices

Turning now to FIG. 2, a computing device 200 that may be used with one or more of the computational systems is described. The computing device 200 may include a processor 203 for controlling overall operation of the computing device 200 and its associated components, including RAM 205, ROM 207, input/output device 209, communication interface 211, and/or memory 215. A data bus may interconnect processor(s) 203, RAM 205, ROM 207, memory 215, I/O device 209, and/or communication interface 211. In some embodiments, computing device 200 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 209 may include a microphone, keypad, touch screen, and/or stylus through which a user of the computing device 200 may provide input, and may also include one or more of a speaker for providing audio output and a video display device for providing textual, audiovisual, and/or graphical output. Software may be stored within memory 215 to provide instructions to processor 203 allowing computing device 200 to perform various actions. Memory 215 may store software used by the computing device 200, such as an operating system 217, application programs 219, and/or an associated internal database 221. The various hardware memory units in memory 215 may include volatile and nonvolatile, removable and non-removable media implemented in any method or technology for storage of information such as computer-readable instructions, data structures, program modules, or other data. Memory 215 may include one or more physical persistent memory devices and/or one or more non-persistent memory devices. Memory 215 may include, but is not limited to, random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Communication interface 211 may include one or more transceivers, digital signal processors, and/or additional circuitry and software for communicating via any network, wired or wireless, using any protocol as described herein.

Processor 203 may include a single central processing unit (CPU), which may be a single-core or multi-core processor, or may include multiple CPUs. Processor(s) 203 and associated components may allow the computing device 200 to execute a series of computer-readable instructions to perform some or all of the processes described herein. Although not shown in FIG. 2, various elements within memory 215 or other components in computing device 200, may include one or more caches including, but not limited to, CPU caches used by the processor 203, page caches used by the operating system 217, disk caches of a hard drive, and/or database caches used to cache content from database 221. For embodiments including a CPU cache, the CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the invention.

### Using Quick Response Code to Extend Access to an Account

The delegation system described herein may extend a temporary access to an account to people other than an account holder via a virtual card. The account holder of the virtual card may set an artificial credit limit and/or an activity period. The virtual card may be generated with a virtual number in the similar format of the card number of the underlying account. The merchant, such as a POS or relay server may not be aware of the nature of the virtual card and may accept the virtual card and process transactions in the similar fashion as handling payment cards, such as a Visa or Master card. The virtual number may be encrypted and securely delivered to a recipient via a computer-readable code. The delivery mechanism may implement an increased security where the computer-readable code may be delivered to an electronic wallet of the recipient, thus hiding the computer-readable code and the virtual number from plain views. The cardholder may dynamically change the artificial credit limit and/or activity period without changing the virtual number or the computer-readable code. The cardholder may also readily revoke the virtual card and/or the virtual card may be expired without any interactions from the recipient. As such, the delegation system may extend access to an account associated with a payment card with transparency and flexibility, while preserving the integrity and security of the confidential data of the underlying payment card.

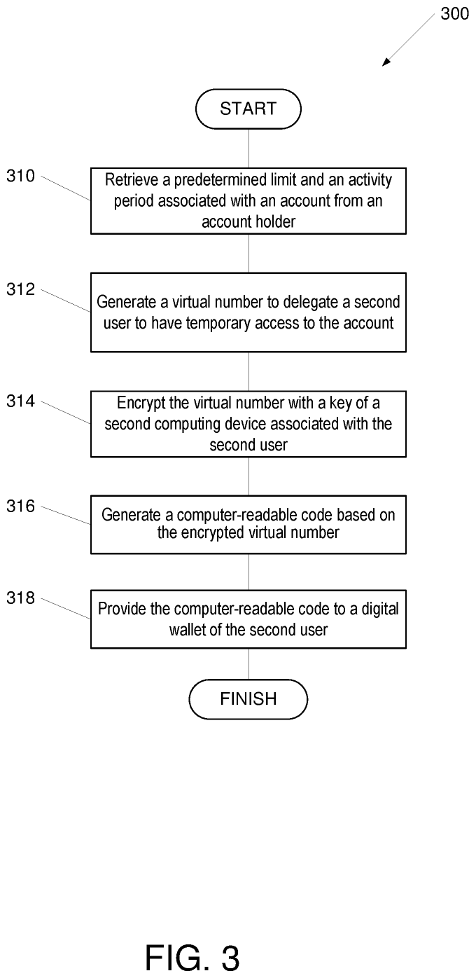

FIG. 3 shows a flow chart of a process 300 for using computer-readable code to extend access to an account according to one or more aspects of the disclosure. Some or all of the steps of process 300 may be performed using one or more computing devices as described herein.

At step 310, a computing device (e.g. a delegation server) may receive, from a first computing device, a request to extend access to an account to a second computing device. The request may comprise a predetermined limit and/or an activity period associated with an account may be received from an account holder. The account holder may use a first computing device executing an application that communicates with a financial institution that issues a payment card, such as a credit card, a debit card or a gift card. The application may provide a configuration page for the account holder to create a virtual card and/or extend access to the account to a recipient of the virtual card. The account holder may wish to provide a temporary access to the underlying payment card for limited purposes with a limited time frame. The configuration page may contain fields such as a predetermined limit and/or a predetermined activity period. For example, the cardholder of the account may set the spend limit to be $50 over an activity period of 10 hours. The configuration page may contain fields, such as whether the virtual card is for one time use or for multiple uses. For example, the cardholder may stipulate the virtual card may expire after a first purchase even there may be remaining balance on the virtual card. Alternatively, the cardholder may allow for multiple uses where the recipient may spend the $50 in multiple purchases. The configuration page may contain fields such as a type of spending that is allowed for the virtual card. For example, the virtual card may be used to purchase groceries, but not alcohol. The configuration page may contain fields such as the payment method of the virtual card. For example, the virtual card may be used for payment occurred in a physical store, but not for online purchases.

At step 312, the computing device may generate a virtual number to delegate temporary access to the account to a second user. The virtual number may be linked to the underlying payment account. The virtual number may also be mapped to a record in a delegation database comprising an identifier of the underlying account, the predetermined limit, and/or the predetermined activity period. In a variety of embodiments, the delegation server may generate the virtual number in the similar format of the card number of the underlying payment card. For example, the virtual number may mimic the format of a primary account number (PAN), or a card number which may be the card identifier found on payment cards, such as credit cards, debit cards, stored-value cards, gift cards and other similar cards. A PAN may be a bank card number that may be a card identifier and may not directly identify the bank account number to which the card may be linked by the issuing entity. The PAN may contain a prefix field that may identify the cardholder of the card. The digits that follow the prefix field may be used by the issuing entity, such as a financial institution, to identify the cardholder as a customer and may be associated by the issuing entity with the customer's designated bank accounts. PAN may be allocated in accordance with International Organization for Standardization (ISO)/International Electrotechnical Commission (IEC) 7812.

In a variety of embodiments, the PAN may be an 8-19 digit number that uniquely identifies a payment account. The leading six or eight digits of the card number may comprise the issuer identification number (IIN) referred to as the “bank identification number (BIN)”, the first digit of which may be the major industry identifier (MII). The remaining numbers on the card, except the last digit, may be the individual account identification number, which may be a variable length (up to 12 digits) individual account identifier. The last digit may be the Luhn check digit calculated using the Luhn algorithm. For example, a Master Card may have a PAN with a length of 16 digits and a Visa Card may have a PAN with a length of 13 or 16 digits.

The virtual number may be generated to mimic the internal structure of the PAN of the payment card. For example, the virtual number may contain a first six digits IIN that identify the same financial institution that issues the underlying payment card that the virtual number is linked to. Through the same IIN, a transaction request containing the virtual number may be routed to the same financial institution that issues the underlying card. The delegation server may generate the remaining digits of the virtual number randomly or follow a certain pattern to map to the underlying card number. For example, the delegation server may reserve certain digits in the virtual number to indicate the nature of the card—that the card is a virtual card generated by a cardholder or account holder for a temporary use, rather than a formal payment card officially issued by the financial institution. The delegation server may store in a delegation database, a reference between the virtual card and the underlying payment card. For example, the delegation server may store a record comprising the virtual number, the identifier of the underlying payment card, the predetermined limit, and the activity period associated with the account. The record may also store additional fields that contain restrictions on the virtual card, such as a one-time use restriction, a purchase type restriction, etc. A relay server may receive a transaction request with the virtual number and forward the transaction request to the financial institute for authorization without the knowledge that the card associated with the virtual number is actually a virtual card. To preserve the privacy and security of the underlying payment card, the virtual number may not be the same as the PAN or card number of the underlying payment card.

In a variety of embodiments, the delegation server may apply a one-way function to the PAN of the underlying card to generate the virtual number. The one-way function may be easy to compute on an input, such as a virtual number, but hard to invert to identify the virtual number given the output. The one-way function may include multiplication and factoring, Rabin function, discrete exponential and algorithm, cryptographically secure hash function, and any other mechanisms that have excessive computation complexity in the decoding process.

At step 314, the computing device may encrypt the virtual number with a symmetric key associated with the second user. For example, the symmetric key may be an identifier of a second computing device associated with the second user, such as phone number of a mobile device of the second user. In a configuration page as noted previously, the cardholder may be asked to provide a phone number of the recipient's device. The virtual number may invoke the linkage to the underlying card when the request originated from the cardholder device. The public key may also be any key used for an asymmetric cryptography, where the virtual number may be encrypted with a public key and the encrypted virtual number may be decrypted with the private key.

At step 316, the computing device (e.g. the delegation server) may generate a computer-readable code based on the encrypted virtual number. A computer-readable code may be a type of matrix barcode such as a QR code, or two-dimensional barcode, etc. The computer-readable code may be a machine-readable optical label that may contain information such as data for a locator, identifier, or tracker that points to a website or application. The virtual number may be encrypted and the computer-readable code may provide an additional layer of security with an embedded virtual number that is encrypted. In a variety of embodiments, the delegation server may send a request with the encrypted virtual number to, for example, a QR server to generate the QR code. The QR code may be returned to the delegation server for distribution to the recipient user device. In another example, the delegation server may generate a one-dimensional bar code based on the encrypted virtual number.

In a variety of embodiments, the computer-readable code may embed an URL of the delegation server with the encrypted virtual number. The URL may enable the recipient to call the delegation server and process the virtual number to identify the corresponding record in the delegation database referencing the underlying payment card.

At step 318, the computer-readable code may be provided to a second computing device. The second computing device may be associated with a second user such as a recipient user device. Additionally, the second computing device may comprise a digital wallet configured to receive the computer-readable code. For example, delegation server may send the computer-readable code to the second computing device associated with the second user, and store the computer-readable code as a token in the digital wallet of the second user. The digital wallet may allow one party to make electronic transactions with another party bartering digital currency units for goods and/or services. The recipient of the computer-readable code may purchase products or services on-line or use the second computing device, such as a smartphone, to purchase products and/or services at a store. The computer-readable code may be presented briefly on the screen of the cardholder computing device. Once the computer-readable code is delivered to the digital wallet of the second computing device, the computer-readable code may be hidden from plain view, which may offer extra security on the virtual number. The second computing device—the recipient of the computer-readable code—may use the token in the digital wallet for transactions associated with Google Pay, Apple Pay, Samsung Pay, Fitbit Pay etc.

In a variety of embodiments, the computer-readable code or the encrypted virtual number may be sent to the second computing device via NFC or any other short-range wireless communications. The encrypted virtual number may also be sent to the second computing device via an email or a text message containing a link to the encrypted virtual number. Once the recipient clicks on the link, a notification may be sent to the cardholder device that the virtual card has been activated. The second computing device may also read the computer-readable code from the first computing device. The second user may then use the temporary access to the underlying account to make one or more purchases in accordance with the restrictions put in place by the accountholder.

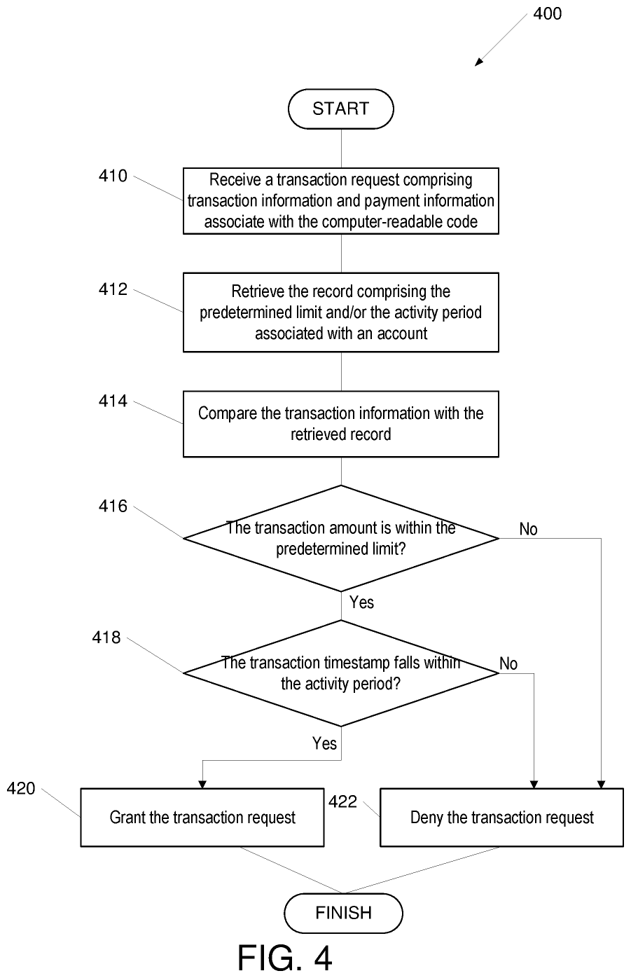

FIG. 4 shows a flow chart of a process of processing a transaction request based on the computer-readable code according to one or more aspects of the disclosure. Some or all of the steps of process 400 may be performed using one or more computing devices as described herein.

At step 410, a computing device may receive a transaction request, which may include transaction information and/or payment information associated with the computer-readable code. For example, a recipient user device of the computer-readable code may send a transaction request to the delegation server. The transaction request may include transaction information, such as a transaction amount, transaction timestamp. The transaction information may include additional information, such as a place of transaction, merchant information, a merchant category which may infer a type of purchase, and/or a phone number of the mobile device remitting payment. The recipient user device may also present payment information in the form of the virtual card such as the computer-readable code.

In a variety of embodiments, the recipient user device may present the computer-readable code to the delegation server via a POS or a relay server. The delegation server may generate the virtual number based on the computer-readable code. In some examples, the computer-readable code may be a QR code and the recipient user device may send a request with the QR code to a QR server, receive a response from the QR server with the encrypted virtual number, decrypt the encrypted virtual number using a private key to extract the virtual number. The recipient user device may send the transaction request with the virtual number to the delegation server for authorization.

At step 412, the computing device (e.g. the delegation server) may retrieve a record comprising the predetermined limit and/or activity period associated with an account based on the virtual number. For example, the delegation may retrieve the record from the delegation database. The record may contain an identifier for the underlying card, a predetermined limit, activity period and other restrictions on the virtual card.

At step 414, the computing device (e.g. the delegation server) may compare the transaction information with the retrieved record. The delegation server may perform some initial steps of rule checking based on the restrictions previously stipulated by the cardholder of the virtual card.

At step 416, the computing device (e.g. the delegation server) may determine whether the transaction amount is within the predetermined amount. For example, a recipient such as a babysitter may attempt to make a purchase of $70 in a store using the virtual card. The delegation server may determine that the virtual card has a $50 spend limit. The process may go to step 422 and the delegation server may deny the transaction after determining that the transaction amount exceeds the predetermined limit of the virtual card. If the transaction amount is within the predetermined amount, the process may go to step 418. Otherwise, the process may go to step 422.

At step 418, the computing device (e.g. the delegation server) may determine whether the transaction timestamp falls within the activity period. If the transaction timestamp is within the activity period, the process may go to step 420 and the delegation server may grant the transaction request. Subsequently, the transaction amount may be deducted from the cardholder's account based on the authority delegated to the second computing device. This debiting process may be processed by the delegation server. Alternatively, the delegation server may forward the transaction request to a separate payment processing server in the financial institution and the payment processing server may deduct the transaction amount from the cardholder's account.

If the computing device determines that the transaction is not within the activity period, the process may go to step 420. For example, the babysitter may attempt to make an online purchase at 8 am using the virtual card. The delegation server may determine that the virtual card has a 10-hour activity period that ends at 8 pm the previous day. The delegation server may determine that the virtual card has expired. The process goes to step 422 and the delegation server may deny the transaction request. The delegation server may deny the transaction request for other reasons. For example, the virtual card may have a restriction for purchases limited to groceries. The delegation server may deny a transaction request that has merchant category associated with the liquor store. The virtual card may stipulate that it is to be used with in-store purchases, and the delegation server may deny a transaction request for an online purchase.

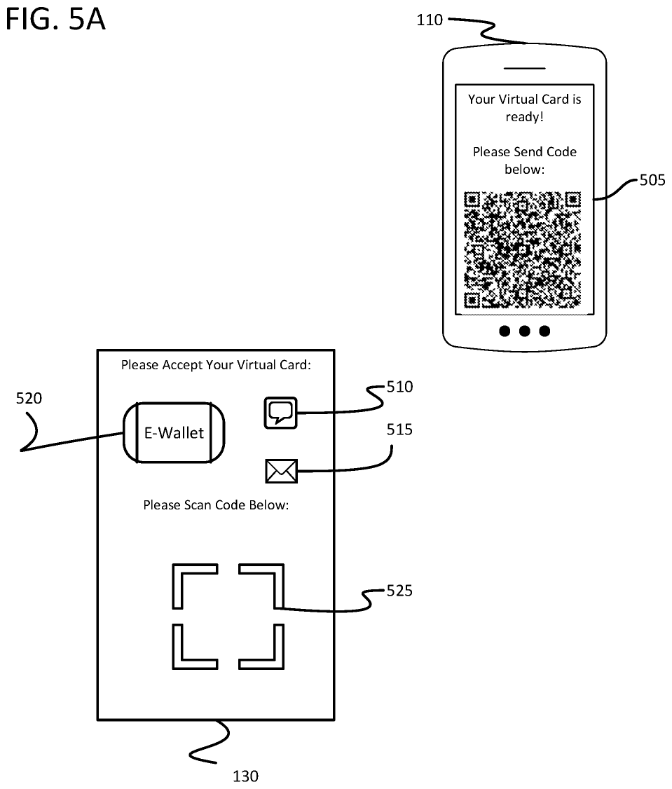

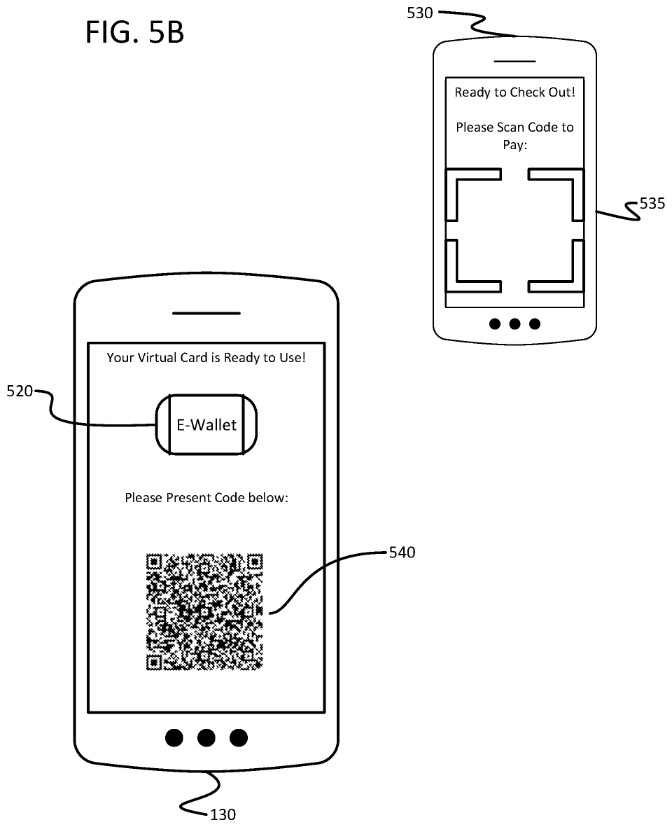

FIGS. 5A-B show an example of using the computer-readable code to extend access to an account according to one or more aspects of the disclosure. FIG. 5A shows an example of an interaction of a first computing device (e.g. cardholder device 110) and a second computing device (e.g. recipient user device 130). In response to successful generating of the virtual card, the display of cardholder device 110 may display computer-readable code 505. Computer-readable code 505 may be transferred to recipient user device 130 in various approaches. Recipient user devices 130 may receive the computer-readable code via an email 515 or text message 510, and the recipient may click on a link in the email or text message to access the virtual card. Recipient user devices 130 may receive the virtual card as a token in the recipient's digital wallet 520. Recipient user devices 130 may receive the virtual card via Near Field Communication (NFC) or other short-range wireless communications when cardholder devices 110 may be in the proximity of recipient user devices 130. Alternatively, the recipient devices 130 may obtain the virtual card by reading the computer-readable code from the cardholder's device. In operation, cardholder device 110 may align the computer-readable code 505 with a scanning component on recipient user device 130. When transfer is successful, the computer-readable code may be displayed on the recipient user device 130. The recipient may then use the temporary access to the underlying account to make one or more purchases in accordance with the restrictions put in place by the accountholder.

FIG. 5B shows an example of interaction between a second computing device (e.g. recipient user device 130) and a third computing device (e.g. a merchant device 530). As shown in FIG. 5B, recipient user device 130 may display the computer-readable code 540. The virtual card may also be stored as a token in digital wallet 520 on recipient user device 130. In the example of using the computer-readable code as the virtual card, the recipient may present the code to a merchant device 530 when the recipient is ready to make the purchase. Merchant device 530 may display a scanning component 535. Recipient user device 130 may align computer-readable code 540 to the scanning component 535 of merchant device 530. When the checkout process is successful, the transaction request may be sent from merchant device 530 to a financial institution for processing as described above.

The techniques described herein may be used to extend a temporary access to a an account or payment card via a computer-readable code. By creating a virtual number for a virtual card and converting the virtual number to the computer-readable code, the virtual card may be delivered to a recipient without exposing the PAN of the underlying payment card. The cardholder of the account or the payment card may stipulate restrictions on the virtual card, dynamically update these restrictions and revoke the virtual card without the need to regenerate the virtual card or the computer-readable code.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
receiving, from a first user on a first computing device, a predetermined limit and an activity period associated with an account, wherein the first user is an account holder of the account;
generating a virtual number to delegate a second user on a second computing device to have temporary access to the account, wherein the virtual number is associated with the account, and the virtual number maps to a record comprising an identifier of the account, the predetermined limit and the activity period;
encrypting the virtual number with a public key of the second computing device;
generating a quick response (QR) code based on the virtual number, wherein the QR code comprises an encrypted form of the virtual number; and
providing, to the second user on the second computing device, the QR code to a digital wallet of the second user, wherein the second user is not the account holder of the account.

2. The computer-implemented method of claim 1, further comprising:
storing, in a transaction database, the record comprising the virtual number, the identifier of the account, the predetermined limit, and the activity period associated with the account.

3. The computer-implemented method of claim 1, further comprising:
receiving a transaction request comprising transaction information and payment information associate with the QR code, wherein the transaction information comprises a transaction amount and a transaction timestamp, and wherein the payment information comprises the virtual number;
retrieving, from a transaction database and based on the virtual number, the record comprising the predetermined limit and the activity period associated with the account;
comparing the transaction information with the retrieved record; and
processing the transaction request based on the comparison.

4. The computer-implemented method of claim 3, further comprising:
granting the transaction request upon a determination that:
the transaction amount is within the predetermined limit; and
the transaction timestamp falls within the activity period.

5. The computer-implemented method of claim 3, further comprising:
denying the transaction request upon a determination that:
the transaction amount exceeds the predetermined limit; or
the transaction timestamp falls outside the activity period.

6. The computer-implemented method of claim 1, further comprising:
revoking, based on a request from the first user, the temporary access to the account.

7. The computer-implemented method of claim 1, further comprising:
updating, based on a request from the first user, at least one of the predetermined limit or the activity period.

8. The computer-implemented method of claim 1, wherein the generating the virtual number associated with the account comprises:
generating the virtual number by applying a one-way function to the identifier of the account.

9. The computer-implemented method of claim 1, further comprising:
receiving, from the first user on the first computing device, a type of purchase associated with the virtual number, and wherein the virtual number further maps to the record comprising the type of purchase.

10. The computer-implemented method of claim 1, wherein the account comprises a bank account or a credit account.

11. A payment system comprising:
one or more processors; and
memory storing instructions that, when executed by the one or more processors, cause the payment system to:
receive, from a first user on a first computing device, a predetermined limit and an activity period associated with an account, wherein the first user is an account holder of the account;
generate a virtual number to delegate a second user on a second computing device to have temporary access to the account, wherein the virtual number is associated with the account, and the virtual number maps to a record comprising an identifier of the account, the predetermined limit, and the activity period;
generate a quick response (QR) code based on the virtual number;
send, to the second user on the second computing device, the QR code to enable the second user to have temporary access to the account, wherein the second user is not the account holder of the account;
receive, from the second user on the second computing device, a transaction request comprising transaction information and payment information associated with the QR code, wherein the transaction information comprises a transaction amount and a transaction timestamp, and wherein the payment information comprises the virtual number;
retrieve, from a transaction database and based on the virtual number, the record comprising the predetermined limit and the activity period associated with the account;
compare the transaction information with the retrieved record; and
process the transaction request based on the comparison.

12. The payment system of claim 11, the instructions, when executed by the one or more processors, cause the payment system to:
grant the transaction request upon a determination that:
the transaction amount is within the predetermined limit; and
the transaction timestamp falls within the activity period.

13. The payment system of claim 11, the instructions, when executed by the one or more processors, cause the payment system to:
deny the transaction request upon a determination that:
the transaction amount exceeds the predetermined limit; or
the transaction timestamp falls outside the activity period.

14. The payment system of claim 11, wherein the account comprises a bank account or a credit account.

15. The payment system of claim 11, the instructions, when executed by the one or more processors, cause the payment system to:
revoke, based on a request from the first user, the temporary access to the account.

16. The payment system of claim 11, the instructions, when executed by the one or more processors, cause the payment system to:
update, based on a request from the first user, the predetermined limit or the activity period.

17. The payment system of claim 11, the instructions, when executed by the one or more processors, cause the payment system to:
generate the virtual number by applying a one-way function to the identifier of the account.

18. One or more non-transitory media storing instructions that, when executed by one or more processors, cause the one or more processors to perform steps comprising:
receiving, from a first user on a first computing device, a predetermined limit and an activity period associated with an account, wherein the first user is an account holder of the account;
generating a virtual number to delegate a second user on a second computing device to have temporary access to the account, wherein the virtual number is associated with the account, and the virtual number maps to a record comprising an identifier of the account, the predetermined limit, and the activity period;
generating a quick response (QR) code based on the virtual number;
sending, to the second user on the second computing device, the QR code to enable the second user to have temporary access to the account, wherein the second user is not the account holder of the account;
receive, from the second user on the second computing device, a transaction request comprising transaction information and payment information associated with the QR code, wherein the transaction information comprises a transaction amount and a transaction timestamp, and wherein the payment information comprises the virtual number;
retrieving, from a transaction database and based on the virtual number, the record comprising the predetermined limit and the activity period associated with the account;
comparing the transaction information with the retrieved record; and
granting the transaction request upon a determination that:
the transaction amount is within the predetermined limit; and
the transaction timestamp falls within the activity period.

19. The non-transitory media of claim 18, the instructions, when executed by the one or more processors, cause the one or more processors to perform steps further comprising:
generating the virtual number by applying a one-way function to the identifier associated with the account.

20. The non-transitory media of claim 19, wherein the virtual number comprises encrypted information associated with the account.
